(19) United States
(12) Patent Application Publication
(10) Pub. No.: US 2025/0012265 A1
(43) Pub. Date: Jan. 9, 2025

(54) COMPRESSED AIR COMPRESSOR AND AIR SUPPLY SYSTEM

(71) Applicant: Aircom Automotive Sp. z o.o. Sp. k., Pietrzykowice (PL)

(72) Inventors: Dominik Gschwender, Zum Gräbberg 1 (CH); Jakub Jeskowiak, Steckborn (CH)

(21) Appl. No.: 18/711,049

(22) PCT Filed: Dec. 1, 2022
(86) PCT No.: PCT/EP2022/084112

§ 371 Date: May 16, 2024

(30) Foreign Application Priority Data
Dec. 2, 2021 (DE) 10 2021 131 829.7

(51) Int. Cl. F04B 39/00; F04B 35/04; F04B 39/12

(52) U.S. Cl. CPC F04B 39/0094; F04B 35/04; F04B 39/0022; F04B 39/12

(57) ABSTRACT

The invention relates to a tire sealing and/or tire inflating device (60) having a compressed-air compressor, and compressed-air compressor comprising a drive, in particular an electric motor (50), for driving a compressor device (20) of the compressor, wherein the compressor device (20) has a piston (26) guided in a cylinder (22) and a crank (30), wherein the crank (30) is coupled to a connecting rod (28) of the piston (26) via an eccentric bearing (38) and to the drive via a gear (48) and has a centric bearing (36), wherein a cylinder axis (34) passes through both the centric bearing (36) of the crank (30) and the eccentric bearing (38) of the crank (30) with the connecting rod (28), when a piston stroke of the piston (26) is at the bottom or top dead center.

The invention relates to a compressed-air compressor and a compressed air supply system, in particular for supplying air for tires of a motor vehicle. The invention relates to a compressed-air compressor with a crank system with one-sided support. This means that the crank system is only borne on one side.

Compressed-air compressors are known as compressed air supply systems from the prior art. For example, compressed air supply systems that can be connected via a sealing liquid container to a pneumatic tire to be sealed are known. The sealing liquid container is, for example, connected to a compressor of the compressed air supply system by an air inlet opening and connected to the tire by an outlet opening via which an air/sealing liquid mixture can exit. During operation of the compressor, sealant enters the tire in a state connected to the tire and can close an opening in the tire, and therefore allows continued travel after a flat tire without a spare tire having to be mounted. In particular, because of such compressed air supply systems, carrying spare tires can be dispensed with, which improves the available space, for example in the trunk of a motor vehicle.

The compressor, in particular a compressor unit of the compressor, is driven, for example, by an electric motor, wherein the compressor device has a piston guided in a cylinder, which is coupled to the electric motor via a gear in order to drive the piston in its reciprocating movement for compressing the air.

It is known in the prior art for crank types with one-sided bearings that the connecting rod runs along the cylinder axis or that the cylinder axis runs through the connecting rod when the piston is at bottom or top dead center of the stroke movement. A central bearing of a crank, which moves the connecting rod, is offset to this cylinder axis. The cylinder axis therefore does not run through the central bearing of the crankshaft. The cylinder axis and the central bearing of the crankshaft are therefore not arranged coaxially. This causes a bending moment to act on the crankshaft. This can lead to an unfavorable coupling between the teeth in the gear, the crank and its central shaft as well as between the crank and the connecting rod and cause faster wear of the gear and the bearings.

The object of the present invention is to provide a solution for arranging elements in compressed-air compressors and compressed air supply systems that is improved compared to the state of the art. In particular, bending moments on the crank and other elements of the compressed-air compressors should be avoided.

This problem is solved by a compressed-air compressor with the features of claim 1. It is provided that a cylinder axis runs both through the centric bearing of the crank and through the eccentric bearing of the crank with the connecting rod when a piston stroke of the piston is at bottom or top dead center.

During the compression stroke, the gas exerts a force Fg on the piston. The force Fg is transmitted to the crank, in particular to the crank bearings. This causes a reaction force RFg to occur at the crank. With the arrangement of the crank according to the invention, in particular the centric bearing of the crank and the eccentric bearing of the crank with the connecting rod, in relation to the cylinder axis, both the force Fg and the reaction force RFg act along the cylinder axis. Therefore, no bending moment acts on the crank.

According to one embodiment, it can be provided that a gear is integrated into the crank. In this case, the same advantages, namely no acting bending moment, also apply to the gear.

According to the invention, the cylinder axis therefore runs through the eccentric bearing of the crank with the connecting rod when a piston stroke of the piston is at bottom or top dead center. In other words, this can also be generalized in that the eccentric bearing of the crank with the connecting rod is arranged in a plane perpendicular to an axis of rotation of the crank, wherein the plane includes the cylinder axis.

The central bearing of the crank is also arranged in this plane.

The feature that the cylinder axis runs both through the centric bearing of the crank and through the eccentric bearing of the crank with the connecting rod means that the cylinder axis runs through the bearings in such a way that the cylinder axis runs within a width of the respective bearing.

In a further development of the inventive concept, it may prove advantageous for the cylinder axis to run through an axis of symmetry of the centric bearing of the crank.

In a further development of the inventive concept, it may prove advantageous for the cylinder axis to run through an axis of symmetry of the eccentric bearing of the crank with the connecting rod when a piston stroke of the piston is at bottom or top dead center. In other words, this can also be generalized in that an axis of symmetry of the eccentric bearing of the crank with the connecting rod runs in a plane perpendicular to an axis of rotation of the crank, wherein the plane includes the cylinder axis, or is enclosed by this plane.

The axis of symmetry of the centric bearing of the crank also advantageously runs in this plane, or is enclosed by this plane.

The centric bearing and/or the eccentric bearing includes, for example, a ball bearing.

In a further development of the inventive concept, it proves advantageous for the cylinder axis to run through a gearwheel of the gear, in particular through an axis of symmetry of the gearwheel of the gear, via which the crank is coupled to the drive.

According to one embodiment, the connecting rod is angled and/or bent. In this embodiment, the bending moment acts on the connecting rod. This can prevent the bending moment from acting on the bearing and gear and prevent the associated wear.

According to one embodiment, the cylinder axis extends at least partially outside the connecting rod.

In a further development of the inventive concept, it proves to be advantageous that the crank comprises at least one balancing weight, and the balancing weight is arranged in a plane perpendicular to an axis of rotation of the crank, wherein the plane comprises the cylinder axis.

Further embodiments relate to a crank for a compressed-air compressor according to the embodiments described. The crank comprises a receptacle for a centric bearing and a receptacle for an eccentric bearing of a connecting rod. According to the present invention, it is provided that the receptacle for the centric bearing and the receptacle for the eccentric bearing are arranged with the connecting rod in a plane perpendicular to an axis of rotation of the crank.

In one embodiment, the crank comprises an integrated gear wheel.

Further embodiments relate to a tire sealing and/or tire inflation device comprising a compressed-air compressor according to the described embodiments and/or a compressed-air compressor with a crank according to the described embodiments.

These and other features of the invention can also be found in the following description as well as in the drawings and the claims.

The invention is explained in more detail below with reference to the drawings. In the figures:

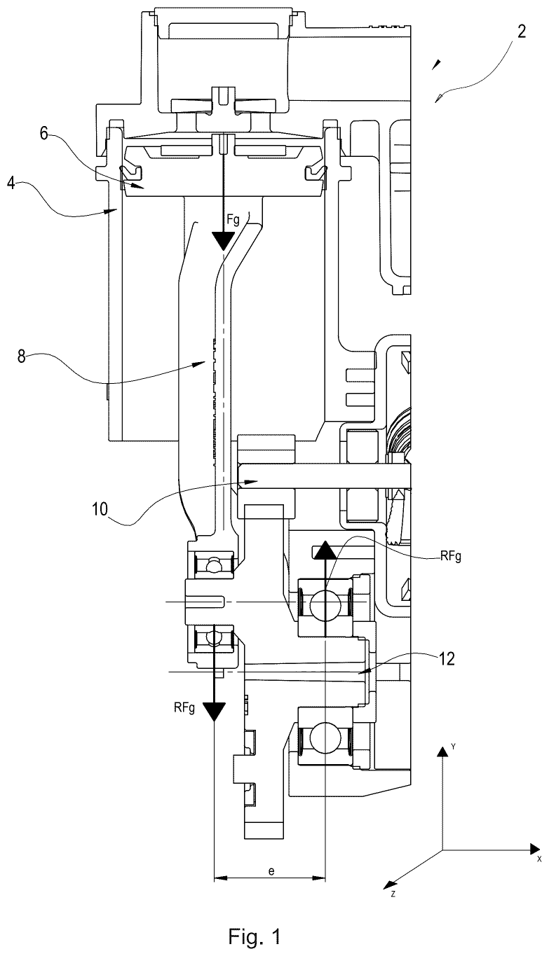

FIG. 1 shows a schematic representation of a compressor device of a compressed-air compressor known from the prior art;

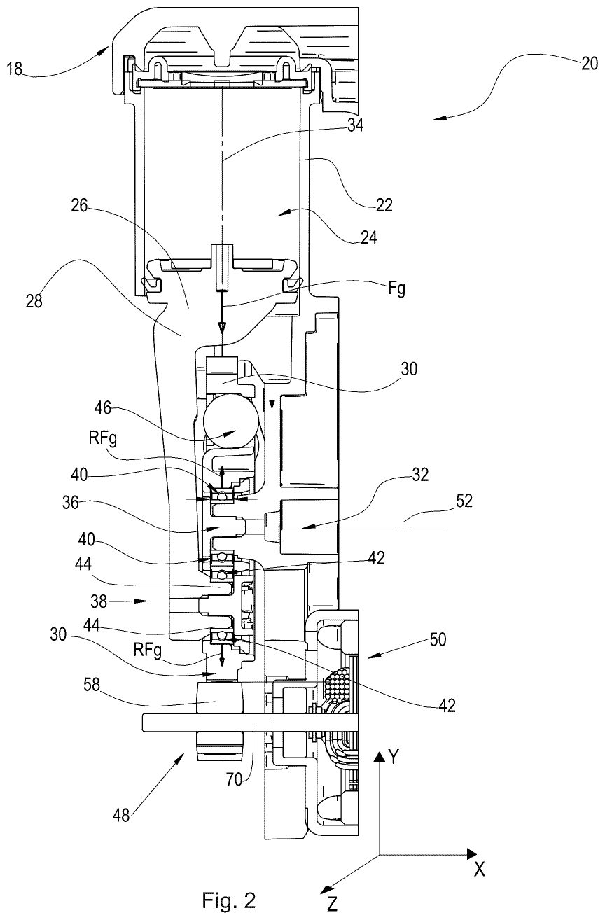

FIG. 2 shows a schematic representation of a compressor device of a compressed-air compressor according to the invention;

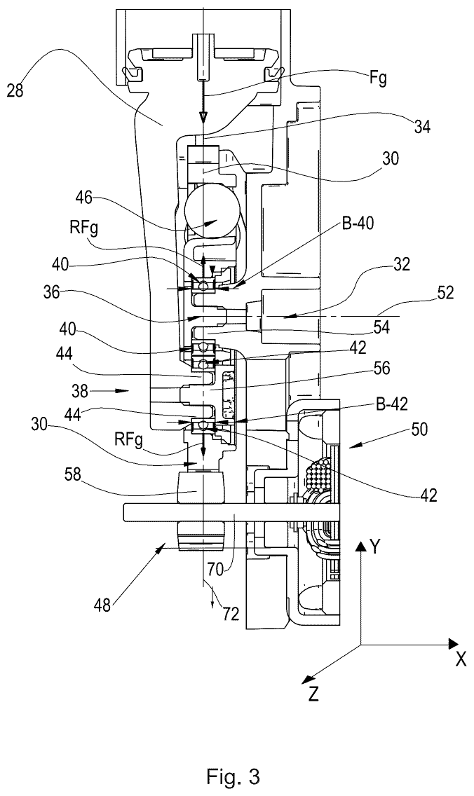

FIG. 3 shows detail view of the representation from FIG. 2; and

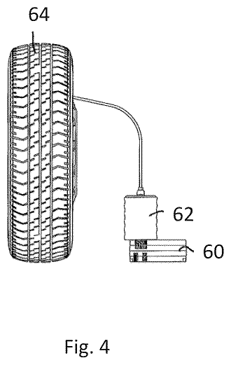

FIG. 4 shows a schematic representation of a compressed air supply system with a sealing fluid container and a tire.

FIG. 1 shows a compressor device 2 of a compressed-air compressor known from the prior art with a crank type borne on one side.

A compressor device 2 comprises a cylinder housing 4 with a piston 6 arranged therein. The piston 6 is coupled to a gearwheel 10 via a connecting rod 8. The gearwheel 10 is coupled to a central shaft of the crank 12.

FIG. 2 shows a compressor device 20 of a compressed-air compressor according to the invention. The compressor device 20 comprises a cylinder chamber 24 enclosed by a cylinder housing 22. Furthermore, an exhaust valve 18 is arranged on the cylinder chamber 24 according to the embodiment shown. Compressed air is discharged from cylinder chamber 24 via the exhaust valve. A piston 26 is arranged in the cylinder chamber 24. The piston 26 is coupled to a crank 30 via an eccentric bearing 42 of a connecting rod 28.

The compressed-air compressor is a crank system with support on one side. This means that the crank system is only borne on one side.

The crank 30 is coupled via a gear 48 to an electric motor 50, which is not shown in full, in order to drive the piston 30 in its stroke movement for compressing the air.

Furthermore, the crank 30 comprises a central bearing 36. The crank is rotatably mounted on a locating shaft 32 via the central bearing 36.

A cylinder axis is marked with the reference symbol 34. The crank 30 is arranged in such a manner that the cylinder axis 34 passes through the crank 30. The cylinder axis 34 runs both through the centric bearing 36 of the crank and through the eccentric bearing 38 of the crank 30 with the connecting rod 28 when a piston stroke of the piston 26 is at bottom or top dead center. According to the illustrated embodiment, the piston stroke of piston 26 is at the bottom dead center.

During the compression stroke, a force Fg is exerted on the piston 26. This force Fg is transmitted to the crank 30 via the connecting rod 28. A reaction force RFg occurs at the crank 30. With the arrangement of the crank 30 according to the invention, in particular the centric bearing 36 of the crank 30 and the eccentric bearing 38 of the crank 30 with the connecting rod 28, in relation to the cylinder axis 34, both the force Fg and the reaction force RFg act along the cylinder axis 34. Therefore, no bending moment acts on the crank 30.

According to FIGS. 2 and 3, the crank 30 comprises an integrated gear wheel. In this case, the same advantages, namely no acting bending moment, also apply to the gear.

For comparison, please refer to FIG. 1, which shows the compressor device 2 known from the prior art. FIG. 1 shows that the gearwheel 10, in particular a bearing by means of which the gearwheel 10 is mounted relative to the central shaft of the crank 12, is arranged offset to the cylinder axis. As a result, the bending moment M=Fg×e acts on the gearwheel 10.

Returning to FIG. 2, according to the embodiment shown, the central bearing 36 of the crank 30 is arranged in such a manner that the cylinder axis 34 extends through the central bearing 36 of the crank 30.

Furthermore, according to the embodiment shown, it is provided that the eccentric bearing 38 of the crank 30 with the connecting rod 28 is arranged in such a manner that the cylinder axis 34 extends through the eccentric bearing 38 of the crank 30 with the connecting rod 28 when a piston stroke of the piston 26 is at bottom or top dead center.

In other words, this can also be generalized by describing that the eccentric bearing 38 of the crank 30 is arranged with the connecting rod 28 in a plane perpendicular to an axis of rotation 52 of the crank 30, the plane comprising the cylinder axis 34.

The central bearing 36 of the crank 30 is also arranged in this plane.

A first bearing 40, in particular a ball bearing, is provided on the crank 30 for centric bearing 36 of the crank 30 and a second bearing 42, in particular a ball bearing, for eccentric bearing 42 of the crank 30 with the connecting rod 28.

The feature that the cylinder axis 34 extends both through the centric bearing 36 of the crank 30 and through the eccentric bearing 38 of the crank 30 with the connecting rod 28 includes that the cylinder axis 34 extends through the bearings 40, 42 in such a manner that the cylinder axis 34 extends within a respective width B-40 and B-42 of the respective bearing 40, 42, see FIG. 3.

According to the embodiment shown, it is also provided that the cylinder axis 34 extends through an axis of symmetry 54 of the centric bearing 36, in particular through an axis of symmetry 54 of the bearing 40, see FIG. 3.

According to the embodiment shown, it is also provided that the cylinder axis 34 extends through an axis of symmetry 56 of the eccentric bearing 38, in particular through an axis of symmetry 56 of the bearing 42, when the piston stroke of the piston is at bottom or top dead center. In other words, this can also be generalized by describing that the symmetry axis 56 of the bearing 42 extends in a plane perpendicular to the rotation axis 52 of the crank 30, wherein the plane includes the cylinder axis 34, or is enclosed by this plane.

The axis of symmetry 54 of the bearing 40 also runs in this plane or is enclosed by this plane.

When the piston 26 is at bottom or top dead center of the stroke movement, both the bearing 40 and the bearing 42, 42, and thus the centric coupling 36 and the eccentric coupling 38 are arranged one above the other along the cylinder axis 34 according to the embodiment shown, see FIGS. 2 and 3.

According to the illustrated embodiment, the gear 48, with which the crank 30 is coupled to the electric motor 50, comprises a gearwheel 58 and a drive shaft 70.

According to the embodiment shown, the gearwheel 58 is arranged in such a manner that the cylinder axis 34 extends through the gearwheel 58, in particular through an axis of symmetry 72 of the gearwheel 58.

According to the illustrated embodiment, it can also be seen that the connecting rod 28 is angled and/or bent. This is understood to mean a bend or an angle as shown in the sectional view in FIG. 2. For example, the connecting rod 28 comprises a coupling part 44 projecting relative to the connecting rod 28, wherein the projecting coupling part 44 of the connecting rod 28 forms the eccentric coupling 42 with a corresponding receptacle at the crank 30. The protruding coupling part 44 forms a bend, for example.

Furthermore, the connecting rod 28 is slightly curved, namely bent away from the cylinder axis 34 starting from the projecting coupling part 44 in the direction of the piston 26.

According to the embodiment shown, the crank 30 comprises at least one balancing weight 46. According to the embodiment shown, the balancing weight 46 is arranged in a plane perpendicular to the axis of rotation 52 of the crank 30, wherein the plane comprising the cylinder axis 34.

Finally, FIG. 4 shows a schematic representation of a compressed air supply system 60, which is connected via a sealing fluid container 62 to a pneumatic tire 64 to be sealed or inflated. As shown, the sealing fluid container 62 is directly coupled to the compressed air supply system 60. Alternatively, the sealing liquid container 62 can also be connected to the compressed air supply system 60 via a further connecting element (not shown). In systems according to the embodiment shown, compressed air for introducing sealing liquid, along with additional compressed air for distributing the sealing liquid in the pneumatic tire, is provided by the compressed air supply system 60, wherein the compressed air is conducted through the sealing liquid container 62.

The sealing liquid container 62 is, for example, connected to a compressor of the compressed air supply system 60 by an air inlet opening and is connected to the tire by an outlet opening via which an air/sealing liquid mixture can exit. The compressor, in particular a compressor device of the compressor, is driven, for example, by an electric motor. The compressor of the compressed air supply system 60 advantageously comprises a compressor device 20 according to the embodiment described in connection with FIG. 2.

Alternatively, the compressed air supply system 60 can also be connected directly to the pneumatic tire 64 to be pumped up.

1. A compressed-air compressor comprising a drive for driving a compressor device (20) the compressor device (20) having a piston (26) guided in a cylinder (22) and a crank (30), the crank (30) being coupled to a connecting rod (28) of the piston (26) via an eccentric bearing (38) and to the drive via a gear (48) and having a centric bearing (36), and wherein a cylinder axis (34) extends both through the centric bearing (36) of the crank (30) and through the eccentric bearing (38) of the crank (30) with the connecting rod (28) when a piston stroke of the piston (26) is at the bottom or top dead center.

2. The compressed-air compressor according to claim 1, wherein the cylinder axis (34) runs through an axis of symmetry (54) of the centric bearing (36) of the crank (30).

3. The compressed-air compressor of claim 1, wherein the cylinder axis (34) runs through an axis of symmetry (56) of the eccentric bearing (38) of the crank (30) with the connecting rod (28) when a piston stroke of the piston (26) is at the bottom or top dead center.

4. The compressed-air compressor of claim 1, wherein the centric bearing (36) or the eccentric bearing (38) comprises a ball bearing (40, 42).

5. The compressed-air compressor of claim 1, wherein the cylinder axis (34) extends through a gearwheel (58) of the gear (48), via which crank (30) is coupled to the drive.

6. The compressed-air compressor of claim 1, wherein the connecting rod (28) is angled or bent.

7. The compressed-air compressor of claim 6, wherein the connecting rod (28) is angled or bent such that the cylinder axis (34) extends at least partially outside the connecting rod (28).

8. The compressed-air compressor of claim 1, wherein the crank (30) comprises at least one balancing weight (46), and in that the balancing weight (46) is the balancing weight (46) arranged in a plane perpendicular to an axis of rotation (52) of the crank (30), said plane comprising the cylinder axis (34).

9. A crank (30) for the compressed-air compressor of claim 1, wherein the crank (30) comprises a receptacle for a centric bearing (36, 40) and a receptacle for an eccentric bearing (38, 42) of the connecting rod (28), and wherein the receptacle for the centric bearing (36, 40) and the receptacle for the eccentric bearing (38, 42) are arranged with the connecting rod (28) in a plane perpendicular to an axis of rotation (25) of the crank (30).

10. A tire sealing and/or tire inflating device (60), comprising the compressed-air compressor of claim 1.

11. A tire sealing and/or tire inflating device (60), comprising the compressed-air compressor with a crank (30) according to claim 9.

12. A tire sealing and/or tire inflating device (60), comprising:
a compressed-air compressor having a drive for driving a compressor device (20) the compressor device (20) having a piston (26) guided in a cylinder (22) and a crank (30), the crank (30) being coupled to a connecting rod (28) of the piston (26) via an eccentric bearing (38) and to the drive via a gear (48) and having a centric bearing (36), and wherein a cylinder axis (34) extends both through the centric bearing (36) of the crank (30) and through the eccentric bearing (38) of the crank (30) with the connecting rod (28) when a piston stroke of the piston (26) is at the bottom or top dead center; and,
a crank (30) for the compressed-air compressor, wherein the crank (30) comprises a receptacle for the centric bearing (36) and a receptacle for the eccentric bearing (38) of the connecting rod (28), and wherein the receptacle for the centric bearing (36) and the receptacle for the eccentric bearing (38) are arranged with the connecting rod (28) in a plane perpendicular to an axis of rotation (25) of the crank (30).

13. The compressed-air compressor of claim 1, wherein the drive is an electric motor (50).

14. The compressed-air compressor of claim 5, wherein the cylinder axis (34) extends through an axis of symmetry (72) of the gearwheel (58) of the gear (48), via which crank (30) is coupled to the drive.

15. The compressed-air compressor of claim 1, wherein the centric bearing (36) and the eccentric bearing (38) comprises a ball bearing (40, 42).

16. The compressed-air compressor of claim 1, wherein the connecting rod (28) is angled and bent.

17. The compressed-air compressor of claim 16, wherein the connecting rod (28) is angled and bent such that the cylinder axis (34) extends at least partially outside the connecting rod (28).
